(19) United States
(12) Patent Application Publication
(10) Pub. No.: US 2014/0226261 A1
(43) Pub. Date: Aug. 14, 2014

(54) ELECTRICITY STORAGE DEVICE AND INSULATING COMPOSITION USED THEREIN

(71) Applicant: PANASONIC CORPORATION, Osaka (JP)

(72) Inventor: Motohiro Sakata, Osaka (JP)

(73) Assignee: PANASONIC CORPORATION, Osaka (JP)

(21) Appl. No.: 14/344,034

(22) PCT Filed: Oct. 4, 2012
(86) PCT No.: PCT/JP2012/006383

§ 371 Date: Mar. 10, 2014

(30) Foreign Application Priority Data
Oct. 7, 2011 (JP) 2011-222479

(51) Int. Cl. H01G 11/80

(52) U.S. Cl. CPC H01G 11/80
USPC 361/502; 524/239

(57) ABSTRACT

An electricity storage device includes an electricity storage element, an electrolytic solution, a case, and a sealing member. The electricity storage element includes a positive electrode, a negative electrode facing the positive electrode, and a separator interposed between these electrodes. The electricity storage element is impregnated with the electrolytic solution. The case houses the electricity storage element and the electrolytic solution. The sealing member seals the opening of the case. At least a part of the sealing member is composed of an insulating composition containing a gas permeable base material and a primary amine compound as an additive.

### TECHNICAL FIELD

The present invention relates to an electricity storage device that can be used in various electronic equipment or mounted on vehicles, and also to an insulating composition applied to a sealing member of the electricity storage device.

### BACKGROUND ART

FIG. 5 is a sectional view of an electric double layer capacitor as an example of a conventional electricity storage device. The electric double layer capacitor includes capacitor element 101, an electrolytic solution (not illustrated), metallic case 102, sealing rubber 103, and a pair of lead terminals 104A and 104B. Capacitor element 101 includes a pair of positive and negative electrodes, and is impregnated with the electrolytic solution. Case 102 houses capacitor element 101 and the electrolytic solution. Sealing rubber 103 with through-holes seals the opening of case 102. Lead terminals 104A and 104B are electrically connected to the positive electrode and the negative electrode, respectively, of capacitor element 101, and are led out through the through-holes of sealing rubber 103. Sealing rubber 103 is made, for example, of silicone rubber, ethylene-propylene rubber, butyl rubber, or peroxide vulcanized rubber (see, for example, Patent Literature 1).

### CITATION LIST

### Patent Literature

Patent Literature 1: Japanese Unexamined Patent Publication No. 2006-324641

### SUMMARY OF THE INVENTION

The present invention is directed to provide an electricity storage device that releases gas to the outside of the device preferentially over infiltration of moisture into the device, thereby reducing the risk of explosion and other problems due to internal pressure increase. The electricity storage device of the present invention includes an electricity storage element, an electrolytic solution, a case, and a sealing member. The electricity storage element includes a positive electrode, a negative electrode facing the positive electrode, and a separator interposed between these electrodes, and is impregnated with the electrolytic solution. The case houses the electricity storage element and the electrolytic solution. The sealing member seals an opening formed in the case. At least a part of the sealing member is composed of an insulating composition containing a gas permeable base material and a primary amine compound as an additive. In this electricity storage device, the rubber body containing the primary amine compound allows the passage of the gas (CO₂ or the like) generated by the decomposition of the electrolytic solution more selectively than gases of other elements. As a result, the gas generated in the electricity storage device is preferentially discharged, thereby improving reliability against a pressure increase in the case.

### BRIEF DESCRIPTION OF DRAWINGS

FIG. 1A is a front view of an electricity storage device according to an exemplary embodiment of the present invention.

FIG. 1B is a partial sectional view of the electricity storage device shown in FIG. 1A, showing a terminal plate and its vicinity.

FIG. 2 is a developed perspective view of an electricity storage element of the electricity storage device shown in FIG. 1A.

FIG. 3 is a graph showing the relationship between the amount of an additive to be added to a rubber body of the electricity storage device and the improvement rate of CO₂ permselectivity according to the exemplary embodiment of the present invention.

FIG. 4A is a plan view of another electricity storage device according to the exemplary embodiment of the present invention.

FIG. 4B is a front sectional view of the electricity storage device shown in FIG. 4A.

FIG. 5 is a front sectional view of a conventional electricity storage device.

### DESCRIPTION OF EMBODIMENTS

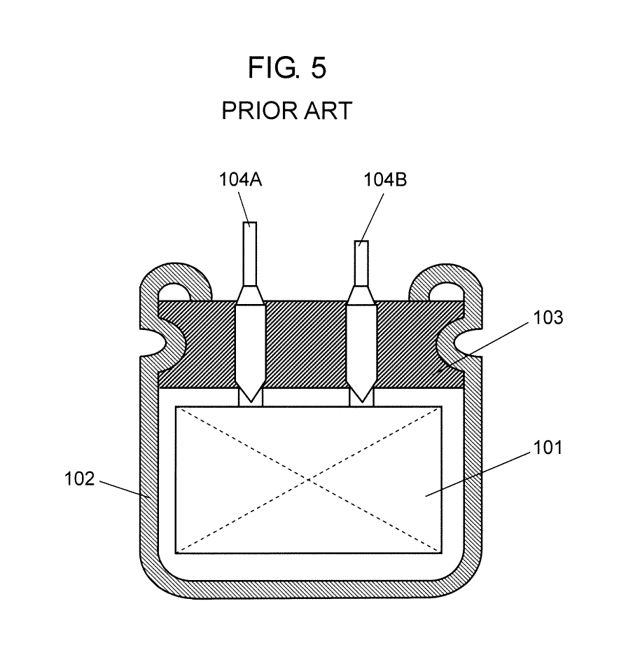

Problems with the conventional electric double layer capacitor will now be described prior to describing an exemplary embodiment of the present invention. In the electricity storage device shown in FIG. 5, the opening of case 102 is sealed with sealing rubber 103. Sealing rubber 103 is required not only to be hermetic enough to prevent leakage of the electrolytic solution but also to be gas permeable enough to release the gas generated by the decomposition of the electrolytic solution from inside to outside of case 102. If, in the future, the electricity storage device is required to be charged and discharged under severe conditions such as high withstand voltage and high temperature, this would result in more generation of gas. For this reason, it is essential for electricity storage devices to have higher gas permeability.

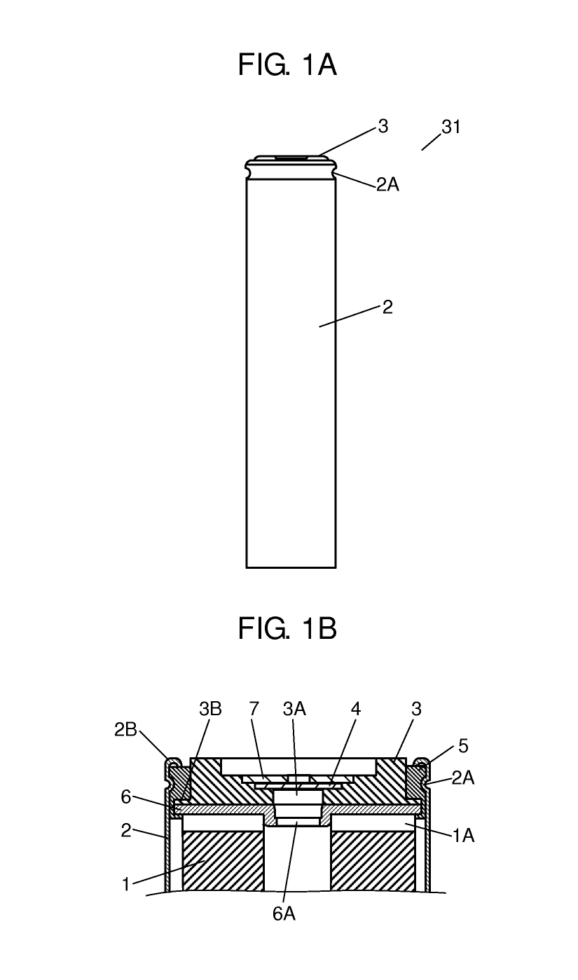

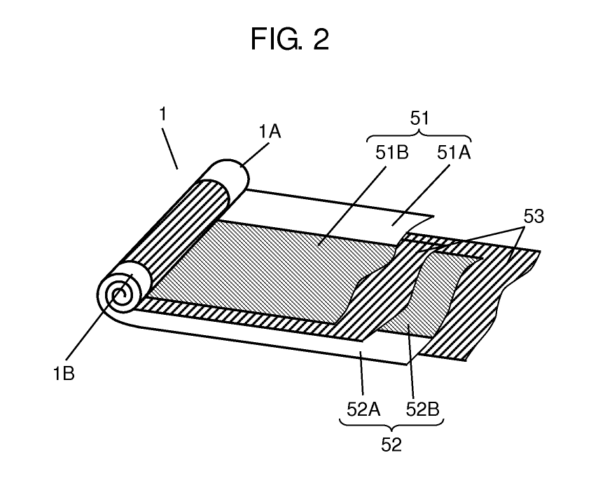

The exemplary embodiment, which achieves this goal, will now be described as follows. FIG. 1A is a front view of electricity storage device 31 according to the exemplary embodiment, and FIG. 1B is a partial sectional view of electricity storage device 31, showing a terminal plate and its vicinity. FIG. 2 is a developed perspective view of electricity storage element 1 of electricity storage device 31 shown in FIG. 1A.

Electricity storage device 31 includes electricity storage element 1, bottomed cylindrical metallic case 2, intermediate body 6 in the form of a metal plate, metal terminal plate 3, insulating member 5, rubber body 4, and fixing member 7.

As shown in FIG. 2, electricity storage element 1 includes positive electrode 51, negative electrode 52, and separators 53, all of which are wound together in such a manner that separators 53 are disposed between electrodes 51 and 52. Positive electrode 51 includes current collector 51A, and positive electrode material layer 51B. Positive electrode material layer 51B is formed on both surfaces of current collector 51A in such a manner that current collector 51A is partially exposed. Similarly, negative electrode 52 includes current collector 52A and negative electrode material layer 52B. Negative electrode material layer 52B is formed on both surfaces of current collector 52A in such a manner that current collector 52A is partially exposed. The area in which current collector 51A is exposed is positive electrode end 1A, whereas the area in which current collector 52A is exposed is negative electrode end 1B. As a result, positive electrode 51 and negative electrode 52 are led out from the opposite ends of electricity storage element 1 in its winding axis direction.

Case 2 houses electricity storage element 1 together with the unillustrated electrolytic solution. Intermediate body 6 is joined to positive electrode end 1A. Terminal plate 3 is joined to the outer surface of intermediate body 6 joined to positive electrode end 1A, thereby terminal plate 3 is electrically connected to electricity storage element 1. Terminal plate 3 is used as an electrical lead-out portion disposed in the opening of case 2. Insulating member 5 is disposed between a side surface of terminal plate 3 and the inner circumferential surface of case 2. Rubber body 4 clogs vertical through-hole 3A formed in terminal plate 3. Fixing member 7 fixes rubber body 4 from above.

The inner bottom surface of case 2 is electrically connected to negative electrode end 1B of electricity storage element 1. To establish electrical connection, electricity storage element 1 may be joined to the inside bottom surface of case 2 either directly or via a metal plate similar to intermediate body 6.

Current collectors 51A and 52A are made of conductive foil. As described above, in electricity storage element 1, positive electrode material layer 51B and negative electrode material layer 52B are formed in such a manner that the exposed area of current collector 51A is formed along one side of the positive electrode, whereas the exposed area of current collector 52A is formed along one side of the negative electrode. The positive and negative electrode are displaced from each other in such a manner that the exposed areas of current collectors 51A and 52A project in the directions opposite to each other. Positive and negative electrodes 51 and 52 disposed opposite to each other are wound together with separators 53 entirely interposed between these electrodes, thereby forming electricity storage element 1. Electricity storage element 1 has a wound shape, and the exposed areas of the current collectors of the electrodes project in the directions opposite to each other in the winding axis direction.

Current collectors 51A and 52A can be made, for example, of Al, Ti, Zr, Hf, Nb, Ta, Cr, Mo, W, Mn, Si, Fe, Ag, Pd, Ni, Cu, Pt, Au, or alloys thereof.

The positive and negative electrode materials can be, for example, a porous carbon material such as activated carbon. In this case, electricity storage element 1 is charged and discharged by absorbing and desorbing cations and anions on the surface of the carbon material. Positive and negative electrode material layers 51B and 52B may contain a binder, a conductive additive, and other materials in addition to the carbon material.

Separators 53 are made of insulating sheet material such as paper or resin. Separators 53 can be of any insulating sheet material but are preferably made of paper such as cellulose, or resin film such as polypropylene, polyethylene, and aramid.

Intermediate body 6 is a metal plate joined to positive electrode end 1A by, for example, welding. It is preferable that intermediate body 6 have through-hole 6A around the center of the winding axis of electricity storage element 1 so that electricity storage element 1 can be more easily impregnated with the electrolytic solution.

Terminal plate 3 is a metal member joined to the outer surface of intermediate body 6 joined to electricity storage element 1. Terminal plate 3 functions as a sealing plate to seal most part of the opening of case 2 and also has the function of electrically leading out positive electrode 51, which is one of the electrodes of electricity storage element 1. Terminal plate 3 has flange 3B near the joint boundary between its side surface and electricity storage element 1.

Case 2 is made of metal and is in the form of a bottomed cylinder. Considering joining with current collector 52A, it is preferable that case 2 be made of the same metal as current collector 52A. Similarly, considering joining with current collector 51A, it is preferable that intermediate body 6 and terminal plate 3 be made of the same metal as current collector 51A. Considering workability, however, case 2 may be made of a different metal from the other components, such as aluminum, iron, stainless steel, nickel, or copper.

Rubber body 4 is formed in through-hole 3A of terminal plate 3 communicating between the inside and outside of case 2. Rubber body 4 is composed of an insulating composition containing a rubber material as a base material and a primary amine compound as an additive.

Fixing member 7 fixes rubber body 4 in through-hole 3A by pressing the upper surface of rubber body 4. Fixing member 7 is preferably made of iron, stainless steel, copper, nickel, aluminum, etc.

Insulating member 5 is disposed between the side surface of terminal plate 3 and the inner side surface of case 2, thereby preventing a short circuit between case 2 and terminal plate 3. It is preferable that insulating member 5 be made from a rubber material such as butyl rubber and ethylene-propylene rubber because of their excellent insulating properties and workability. Insulating member 5 is locked by flange 3B of terminal plate 3. Furthermore, the vicinity of insulating member 5 is firmly sealed with drawn portion 2A formed from the outside of case 2 toward the outer surface of terminal plate 3. At the end of the opening of case 2, there is provided curled portion 2B which is curled inside case 2. Curled portion 2B increases the sealing effect in the vicinity of insulating member 5 sealed more securely.

Rubber body 4 is formed in through-hole 3A to clog it, thereby sealing a part of the opening of case 2 in cooperation with terminal plate 3. In electricity storage device 31, rubber body 4 functions as a part of the sealing member and has the function of releasing the gas generated inside case 2. Thus, in the configuration shown in FIG. 1B, terminal plate 3, rubber body 4, fixing member 7, and insulating member 5 together form the sealing member to seal the opening of case 2. At least a part of the sealing member is composed of an insulating composition containing a gas permeable base material and a primary amine compound as an additive.

Preferably, the additive contained in rubber body 4 is a primary amine-containing acrylic acid copolymer shown in Chemical Formula (1) below. The rubber material is made of at least one of silicone rubber, butyl rubber, and ethylene-propylene rubber.

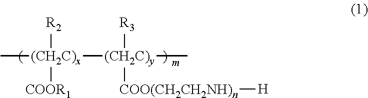

where each of R₁, R₂, and R₃ is preferably either hydrogen or an alkyl group but may not be limited to those, and each of x, y, n, m is a positive number.

Rubber body 4 can be formed by adding the above-mentioned additive during the process of producing a general rubber material. More specifically, first of all, a rubber raw material and various kinds of fillers are kneaded in a kneading machine. Next, the resultant rubber sheet is kneaded with the above-mentioned additive and a cross-linking agent in the kneading machine. Finally, the resultant kneaded product is cross linked. This results in the preparation of the insulating composition as a material of rubber body 4. Alternatively, the above-mentioned additive may be added to the cross-linked rubber material.

The additive may be added to the rubber material after being dissolved in a solvent such as water, toluene, methyl isobutyl ketone, or isopropyl alcohol. In this case, the ratio of the additive in terms of solid content to the solvent is preferably in the range of 29 wt % to 57 wt %, inclusive, and more preferably in the range of 29 wt % to 37 wt %, inclusive. The additive may be added in powder form instead of being dissolved in a solvent as mentioned above.

The gas generated due to the decomposition of the electrolytic solution is mainly carbon dioxide (CO₂). Rubber body 4 composed of the above-mentioned insulating composition has high CO₂ permeability, and therefore, has increased reliability against a pressure increase inside case 2. The primary amine has a high affinity for CO₂ in terms of chemical structural formula, thus the additive attracts CO₂. It is likely that, from a microscopic point of view, an increase in local CO₂ concentration allows CO₂ to permeate rubber body 4 more easily due to the concentration gradient, thereby improving CO₂ permselectivity.

Rubber body 4 can be hermetic with respect to moisture which may come from outside case 2 similar to the conventional rubber material. This prevents electricity storage device 31 from causing hydrolysis therein, and hence, property degradation can be suppressed.

Rubber body 4 can be effective when disposed in the opening of case 2 in such a manner that a part of the surface of rubber body 4 is exposed in case 2 and another part of the surface is exposed outside case 2.

As described above, the provision of rubber body 4 can increase the permeability of the gas generated mainly due to the decomposition of the electrolytic solution contained in case 2, while preventing infiltration of moisture from outside case 2.

To increase the above effect, it is preferable that the amine number, which indicates the amine content (mmol) in 1 g of the additive in solid content, be in the range from 0.6 to 2.7, inclusive. It is also preferable that the amine hydrogen equivalent weight, which indicates the solid content weight (g) of the additive corresponding to 1 mol of amine, is in the range from 350 to 1800, inclusive. It is also preferable that the additive composed of the primary amine compound be a polymer compound, and it is more preferable that the polymer compound contains a functional group (—NH₂) of primary amine at the side chain terminal. Thus, CO₂ permeability can be improved by using the primary amine as the additive at the terminal where the primary amine is subject to chemical change with other compounds in terms of the chemical structure.

If insulating member 5 is made of a rubber material, the rubber material may be composed of the insulating composition containing the above-mentioned additive in the same manner as rubber body 4. This allows insulating member 5 also to have excellent gas permeation performance.

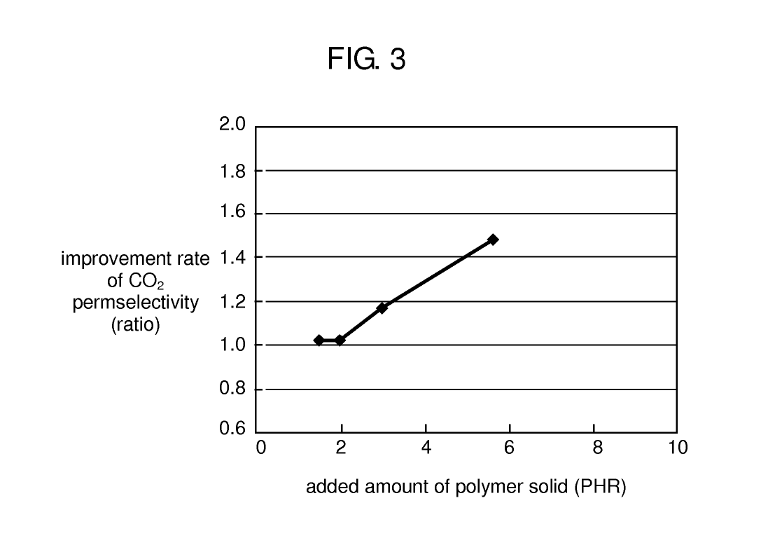

Table 1 and FIG. 3 show the results of a performance evaluation test given to specific examples of rubber body 4 in order to evaluate their gas permeability and moisture resistance by gas chromatography.

This test has the purpose of quantitatively evaluating the ability of the rubber body to release gas to the outside of electricity storage device 31 preferentially over infiltrated of moisture into electricity storage device 31. To achieve this purpose, the improvement rate of CO₂ permselectivity (hereinafter, the improvement rate) is used for showing the ability. The improvement rate is a ratio of the actual CO₂ permeability coefficient of each sample with respect to the moisture permeability coefficient. Table 1 shows the improvement rates of Samples A to D and of a comparative example when the improvement rate of the comparative example is set to 1.0. The gas permeability evaluation is conducted based on the gas chromatography according to JIS K7126-1. The device used in this evaluation process includes a gas permeation cell which allows the gas to permeate a test specimen; a pressure sensor which detects a pressure change due to the permeated gas; a gas supplier which supplies the gas to the gas permeation cell; a cell-volume variable device; and a vacuum pump. The gas permeation cell is composed of an upper chamber (high-pressure side) and a lower chamber (low-pressure side). In this test, first of all, the lower chamber is sealed with the test specimen. When starting the test, the lower chamber is kept in a vacuum state. Then, gas (CO₂) is supplied to the upper chamber so as to allow the gas to permeate the test specimen into the lower chamber. The gas is continuously supplied until the pressure in the upper chamber reaches 1 atm. Then, the pressure change in the lower chamber is measured to evaluate gas permeability. The time from measurement start to end is 2.5 seconds, and the measuring temperature is 25° C. The test specimen has a permeation area of about 0.2 cm² and a thickness of about 2 to 3 mm.

TABLE 1

| | added amount of solid | improvement rate of |
|---|---|---|
| | content (wt %) | CO₂ permselectivity |
| Sample A | 1.5 | 1.01 |
| Sample B | 2.0 | 1.01 |
| Sample C | 3.0 | 1.17 |
| Sample D | 5.7 | 1.47 |
| Comparative example | 0 | 1.00 |

Sample A is a rubber body made from a solution prepared by mixing silicone rubber as a rubber material with toluene and the additive shown in Chemical Formula (1) in such a manner that the added amount of solid content is about 1.5 wt %. The additive can be made, for example, of aminoethylated acrylic polymer. The amine hydrogen equivalent weight is 800 to 1400, and the amine number is 0.7 to 1.3.

Sample B is a rubber body made from a solution prepared by mixing the same rubber of Sample A as the rubber material with toluene and the above additive in such a manner that the added amount of solid content is 2.0 wt %. Sample C is a rubber body made from a solution prepared by mixing the same rubber of Sample A as the rubber material with toluene and the above additive in such a manner that the added amount of solid content is 3.0 wt %. Sample D is a rubber body made from a solution prepared by mixing the same rubber of Sample A as the rubber material with toluene and the above additive in such a manner that the added amount of solid content is about 5.7 wt %. The comparative example is a rubber body made exclusively of a rubber material, which is silicone rubber.

Table 1 indicates that the rubber bodies containing additive more than 2.0 wt % can release the gas from case 2 extremely preferentially over that of the comparative example. And, it is preferable that the added amount of the mixed solution of the additive and the solvent be 2 wt % or more. The reason for this is that, as shown in Table 1, when the additive content is in this range, the improvement rate of CO₂ permselectivity is very high, thereby exhibiting a high ability to release the gas. It is also preferable that the added amount of solid content be 20 wt % or less. The reason for this is that when the additive content is larger than this, it is difficult to maintain the hermeticity of the prepared rubber body and the uniform distribution of the additive. It is also difficult to control the shape of the rubber body, possibly decreasing the yield.

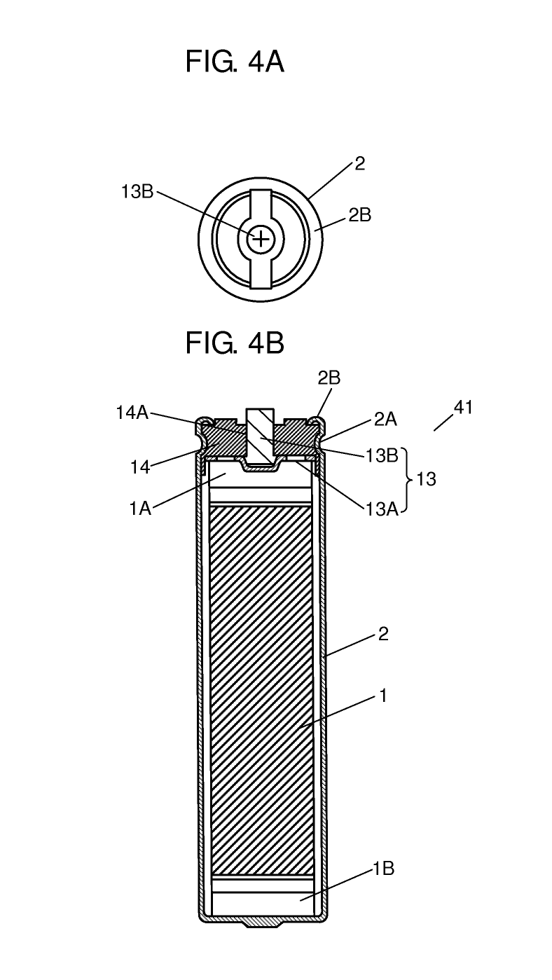

The configuration of the electricity storage device is not limited to the one shown in FIGS. 1A to 2. Another example of the electricity storage device will now be described with reference to FIGS. 4A and 4B. FIG. 4A is a plan view of electricity storage device 41, which is another electricity storage device according to the exemplary embodiment of the present invention. FIG. 4B is a front sectional view of electricity storage device 41.

In electricity storage device 41, electricity storage element 1 has the same configuration as in FIG. 2, and the connection between negative electrode end 1B and case 2 is also the same as described above. The difference is the configuration of the sealing member formed in the opening of case 2.

More specifically, electricity storage element 1 with a wound shape is housed in case 2 together with the electrolytic solution. The opening of case 2 is sealed with a sealing member including terminal plate 13 and rubber body 14, which is composed of the same insulating composition as rubber body 4. Positive electrode end 1A is connected metallic terminal plate 13, whereas negative electrode end 1B is connected to the inner bottom surface of case 2. The inner bottom surface of case 2 may be joined and electrically connected to electricity storage element 1 via a metal plate similar to intermediate body 6.

Terminal plate 13 includes flat part 13A and terminal part 13B. Flat part 13A is connected to electricity storage element 1, and terminal part 13B is formed on flat part 13A and is projecting toward the outside of the opening of case 2. Terminal part 13B is exposed outside through through-hole 14A formed in rubber body 14, and clogs through-hole 14A to seal it. Terminal plate 13 may be made of any conductive material but is preferably made of a metallic material such as aluminum, iron, stainless steel, copper, and nickel.

The outer peripheral surface of rubber body 14 is in contact with the inner circumferential surface of case 2. Drawn portion 2A is formed in the portion of the outer peripheral surface of case 2 that is in contact with rubber body 14. Furthermore, curled portion 2B is formed at the end of the opening of case 2. As a result, rubber body 14 and case 2 are strongly press-contacted to each other to seal the opening.

In electricity storage device 41 with this configuration, rubber body 14 having the function of sealing case 2 and of releasing gas is composed of the same insulating composition as rubber body 4. As a result, electricity storage device 41 requires a smaller number of components than those of electricity storage device 31, thereby providing excellent cost performance. In addition, in electricity storage device 41, rubber body 14 has a larger area which faces the inside of case 2 than in electricity storage device 31, thereby higher gas permeability can be achieved.

As described above, each of electricity storage devices 31 and 41 includes electricity storage element 1, the electrolytic solution, case 2, and the sealing member. Electricity storage element 1 includes positive electrode 51, negative electrode 52 facing positive electrode 51, and separators 53 interposed between positive and negative electrodes 51 and 52. Electricity storage element 1 is impregnated with the electrolytic solution. Case 2 houses electricity storage element 1 and the electrolytic solution. The sealing member seals the opening of case 2. At least a part of the sealing member is composed of the insulating composition containing the gas permeable base material and a primary amine compound as the additive. As a result, electricity storage devices 31 and 41 with high permeability of the gas generated in case 2 while maintaining moisture resistance, and thereby reduced the risk of explosion can be manufactured.

In the conventional electricity storage device shown in FIG. 5, the electrodes are electrically let out to the outside via lead terminals 104A and 104B. The above-described insulating composition can be used for a rubber body even in configurations such as the conventional electricity storage device in which conductive leads are joined to electricity storage element 1 and are in the form of lines, plates, columns, cylinders, etc. in order to lead out the electrodes to the outside through the rubber body. These configurations exhibit similar effects to those of the present embodiments. The structure to seal the opening of case 2 is not limited to the combination of terminal plate 3 as the sealing plate and rubber body 4 used in electricity storage device 31, or to the sealing components used in electricity storage device 41.

Electricity storage element 1 does not necessarily have to have a wound shape described above. For example, electricity storage element 1 may have a laminated structure in which a plurality of positive and negative electrodes are alternately laminated with separators interposed therebetween. Furthermore, positive electrode end 1A of electricity storage element 1 may be joined directly to terminal plate 3 without providing intermediate body 6. This exhibits similar effects to the present embodiment.

Positive electrode material layer 51B and negative electrode material layer 52B are not limited to those described above. For example, they may be made of a lithium alloy, a silicon material, a lithium composite oxide, or a carbon material capable of absorbing cations such as graphite. The electrolytic solution may be amidine salt, onium salt, or lithium salt and is not limited. For example, the electrolytic solution may contain an electrolyte composed of cations such as ethyldimethylimidazolium, ethyltrimethylammonium, and lithium; anions such as hexafluorophosphate and tetrafluoroborate; and a solvent such as a carbonate and a lactone. The solvent can be anything as long as it contains cations and anions.

The electricity storage device is not limited to an electric double layer capacitor but may be a lithium ion capacitor or a lithium secondary battery. In a lithium ion capacitor, lithium ions are absorbed in the negative electrode material formed on the current collector of the negative electrode, thereby providing a higher withstand voltage than that of the electric double layer capacitor. In a lithium secondary battery, the positive electrode contains a lithium-metal composite oxide, whereas the negative electrode contains a carbon material or a silicon compound. A rubber body composed of the above-described insulating composition exhibits similar effects mentioned above especially in electricity storage devices which includes an organic solvent and whose properties are affected by infiltration of moisture.

### INDUSTRIAL APPLICABILITY

The present invention provides a reliable electricity storage device that releases gas from inside the case preferentially over infiltration of moisture into the rubber body provided to seal the opening of the case. This electricity storage device can easily be charged and discharged under severe conditions, and is therefore expected to be used under severe temperature and charge-discharge conditions such as in vehicles.

### REFERENCE MARKS IN THE DRAWINGS

1 electricity storage element
1A positive electrode end
1B negative electrode end
2 case
2A drawn portion
2B curled portion
3, 13 terminal plate
3A, 6A, 14A through-hole
3B flange
4, 14 rubber body
5 insulating member
6 intermediate body
7 fixing member
13A flat part
13B terminal part
31, 41 electricity storage device
51 positive electrode
51A, 52A current collector
51B positive electrode material layer
52 negative electrode
52B negative electrode material layer
53 separator

1. An insulating composition comprising:
a gas-permeable base material; and
an additive,
wherein the additive is a primary amine compound.

2. The insulating composition according to claim 1, wherein the additive is a primary amine compound shown in Chemical Formula (1) below: 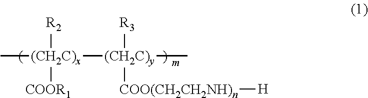
where each of R₁, R₂, and R₃ is either hydrogen or an alkyl group, and each of x, y, n, and m is a positive number.

3. The insulating composition according to claim 1, wherein the base material is made of at least one of silicone rubber, butyl rubber, and ethylene-propylene rubber.

4. The insulating composition according to claim 1, wherein the additive includes solid content in an amount greater than 2 wt % and not more than 20 wt % of a weight of the base material.

5. An electricity storage device comprising:
an electricity storage element including:
a positive electrode;
a negative electrode facing the positive electrode; and
a separator interposed between the positive and negative electrodes;
an electrolytic solution with which the electricity storage element is impregnated;
a case having an opening and housing the electricity storage element and the electrolytic solution; and
a sealing member sealing the opening of the case, a part of the sealing member being composed of the insulating composition of claim 1.

6. The electricity storage device according to claim 5, wherein the additive is a primary amine compound shown in Chemical Formula (1) below: 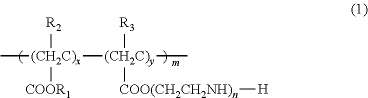
where each of R₁, R₂, and R₃ is either hydrogen or an alkyl group, and each of x, y, n, and m is a positive number.

7. The electricity storage device according to claim 5, wherein the base material is made of at least one of silicone rubber, butyl rubber, and ethylene-propylene rubber.

8. The electricity storage device according to claim 5, wherein the additive includes solid content in an amount greater than 2 wt % and not more than 20 wt % of a weight of the base material.
